(19) United States
(12) Patent Application Publication
(10) Pub. No.: US 2026/0109208 A1
(43) Pub. Date: Apr. 23, 2026

(54) APPARATUS FOR CONTROLLING VEHICLE, SYSTEM INCLUDING THE SAME AND METHOD THEREOF

(71) Applicants: Hyundai Motor Company, Seoul (KR); Kia Corporation, Seoul (KR)

(72) Inventors: Jae Dong Shin, Hwaseong-Si (KR); Sang Sub Um, Hwaseong-Si (KR); Hae Yoon Jung, Hwaseong-Si (KR); Kyeong Chan Lee, Hwaseong-Si (KR); Eon Ryeol Jeon, Hwaseong-Si (KR); Jeong Hoon Park, Hwaseong-Si (KR); Seul Gi Kim, Hwaseong-Si (KR)

(21) Appl. No.: 19/195,904

(22) Filed: May 1, 2025

(30) Foreign Application Priority Data
Oct. 23, 2024 (KR) 10-2024-0146182

(51) Int. Cl. B60J 7/057; B60J 7/043; E05F 15/659

(52) U.S. Cl. CPC B60J 7/0573; B60J 7/043; E05F 15/659; E05Y 2400/30; E05Y 2400/44; E05Y 2900/542

(57) ABSTRACT

The present disclosure relates to a vehicle control apparatus of a vehicle, a system including the same, and a method thereof. The vehicle control apparatus may include a motor that moves a sunroof to an open position or a closed position, a plurality of sensors that detect rotation of the motor, memory that stores sensor values received from the plurality of sensors, and a processor that controls the rotation of the motor based on the sensor values. The processor may adjust the position of the sunroof by reverting a positional change of the sunroof that was, for example, not detected while the vehicle control apparatus was in a sleep mode.

### CROSS-REFERENCE TO RELATED APPLICATION

This application claims priority to Korean Patent Application No. 10-2024-0146182, filed in the Korean Intellectual Property Office on Oct. 23, 2024, the entire contents of which are incorporated herein by reference.

### TECHNICAL FIELD

The present disclosure relates to vehicle control, and more specifically relates to controlling the movement of a sunroof of a vehicle.

### BACKGROUND

In general, as vehicle technologies advance, users'needs and preferences for convenience features are also diversifying.

In particular, as the proportion of vehicles equipped with sunroofs is increasing significantly in line with the preferences of users who care about driving environments, such as comfort while driving, sunroofs are considered a default option in many vehicle purchases.

The increased demand for sunroofs requires additional safety functions to prevent accidents, as various operation accidents may occur during a sunroof operation.

According to one or more example embodiments of the present disclosure, a vehicle control apparatus of a vehicle may include: a motor configured to move a sunroof of the vehicle to one of an open position and a closed position; a plurality of sensors configured to detect rotation of the motor; memory configured to store sensor values that are associated with rotation of the motor and are received from the plurality of sensors; and a processor. The processor may be configured to: store, in the memory, first sensor values, wherein the first sensor values are received from the plurality of sensors while the vehicle control apparatus is in a wakeup mode and before a first time at which the vehicle control apparatus switches from the wakeup mode to a sleep mode; based on the vehicle control apparatus switching from the sleep mode to the wakeup mode at a second time after the first time, compare the first sensor values, stored in the memory, with second sensor values, wherein the second sensor values are received from the plurality of sensors after the second time and while the vehicle control apparatus is in the wakeup mode; determine, based on the comparison indicating that the first sensor values are different from the second sensor values, an adjustment value; and adjust a position of the sunroof by controlling, based on the adjustment value, rotation of the motor.

The plurality of sensors may include: a first Hall sensor and a second Hall sensor, which are placed adjacent to each other on one side of the motor. The first Hall sensor may be configured to detect the rotation of the motor and output a first square wave signal. The second Hall sensor may be configured to detect the rotation of the motor and output a second square wave signal with a phase difference of 90 degrees with respect to the first square wave signal.

The processor may be configured to adjust the position of the sunroof by reverting a positional change of the sunroof that was not detected while the vehicle control apparatus was in the sleep mode. The processor may be further configured to: write, in the memory, the one or more sensor values received from the plurality of sensors while the vehicle control apparatus is in the wakeup mode; and stop writing, in the memory, any additional sensor values while the vehicle control apparatus is in the sleep mode.

The processor may be configured to compare the first sensor values with the second sensor values by: receiving, from the plurality of sensors, the second sensor values while the vehicle control apparatus is in the wakeup mode after switching from the sleep mode; retrieving, from the memory, the first sensor values that were stored while the vehicle control apparatus was in the wakeup mode before switching to the sleep mode; and comparing the first sensor values and the second sensor values.

The processor may be further configured to: identify a current rotational direction of the motor at a third time when the first sensor values are retrieved from the memory, wherein the third time is after the second time at which the vehicle control apparatus switches from the sleep mode to the wakeup mode; and identify, based on the current rotational direction of the motor at the third time being a forward rotational direction, a sensor value, of the first sensor values, that was received when the motor was rotating in the forward rotational direction.

The processor may be further configured to: identify a current rotational direction of the motor at a third time when the first sensor values are retrieved from the memory, wherein the third time is after the second time at which the vehicle control apparatus switches from the sleep mode to the wakeup mode; and identify, based on the current rotational direction of the motor at the third time being a reverse rotational direction, a sensor value, of the first sensor values, that was received when the motor was rotating in the reverse rotational direction.

The processor may be configured to determine the adjustment value by: based on the comparison indicating that one of the first sensor values is different from a corresponding value of the second sensor values, determining a Hall counter adjustment value further based on an edge associated with the different sensor values of the first sensor values and the second sensor values.

The processor may be configured to determine the Hall counter adjustment value by performing one of: based on the edge associated with the different sensor values being a falling edge, determining a first adjustment value as the Hall counter adjustment value for adjusting a Hall counter value by 1; or, based on the edge associated with the different sensor values being a rising edge, determining a second adjustment value as the Hall counter adjustment value for adjusting the Hall counter value by 1.

The processor may be configured to determine the Hall counter adjustment value by: determining an absolute value of the Hall counter adjustment value to be same regardless of whether a rotational direction of the motor is a forward direction or a reverse direction.

The processor may be configured to determine the adjustment value by: based on the comparison indicating that the first sensor values are different from the second sensor values for each of the plurality of sensors, determining a Hall counter adjustment value further based on a previous movement direction of the sunroof.

The processor may be configured to determine the adjustment value by, based on the comparison indicating that the first sensor values are different from the second sensor values for each of the plurality of sensors, performing one of: determining the Hall counter adjustment value for decreasing a Hall counter value by 2 based on the previous movement direction of the sunroof being an opening direction; or determining the Hall counter adjustment value for increasing the Hall counter value by 2 based on the previous movement direction of the sunroof being a closing direction.

The processor may be configured to determine the adjustment value by: based on the comparison indicating that the first sensor values are different from the second sensor values for each of the plurality of sensors, determining a Hall counter adjustment value further based on a spring tension direction of the sunroof.

The processor may be configured to determine the adjustment value by: based on the comparison indicating that the first sensor values are different from the second sensor values for each of the plurality of sensors, determining the Hall counter adjustment value for decreasing a Hall counter value by 2 in the spring tension direction of the sunroof.

According to one or more example embodiments of the present disclosure, a vehicle system of a vehicle may include: a user interface configured to receive a user command for operating a sunroof of the vehicle; and a vehicle control apparatus. The vehicle control apparatus may include: a motor, and a plurality of sensors configured to control movement of the sunroof according to the user command. The vehicle control apparatus may be configured to: receive, from the plurality of sensors while the vehicle control apparatus is in a wakeup mode and before a first time at which the vehicle control apparatus switches from the wakeup mode to a sleep mode, first sensor values; based on the vehicle control apparatus switching from the sleep mode to the wakeup mode at a second time after the first time, compare the first sensor values with second sensor values, wherein the second sensor values are received from the plurality of sensors after the second time and while the vehicle control apparatus is in the wakeup mode; determine, based on the comparison indicating that the first sensor values are different from the second sensor values, an adjustment value; and adjust a position of the sunroof by controlling, based on the adjustment value, rotation of the motor.

According to one or more example embodiments of the present disclosure, a method performed by an apparatus of a vehicle may include: receiving, from a plurality of sensors while the apparatus is in a wakeup mode and before a first time at which the apparatus switches from the wakeup mode to a sleep mode, first sensor values; based on determining that the apparatus has switched from the sleep mode to the wakeup mode at a second time after the first time, comparing the first sensor values with second sensor values, wherein the second sensor values are received from the plurality of sensors after the second time and while the apparatus is in the wakeup mode; determining, based on the comparison indicating that the first sensor values are different from the second sensor values, an adjustment value; and
adjusting a position of a sunroof of the vehicle by controlling, based on the adjustment value, rotation of a motor associated with the sunroof.

Determining the adjustment value may include: based on the comparison indicating that one of the first sensor values is different from a corresponding value of the second sensor values, determining a Hall counter adjustment value for increasing or decreasing a Hall counter value by 1 further based on an edge associated with the different sensor values of the first sensor values and the second sensor values.

Determining the adjustment value may include: based on the comparison indicating that the first sensor values are different from the second sensor values for each of the plurality of sensors, determining a Hall counter adjustment value further based on a previous movement direction of the sunroof.

Determining the adjustment value may further include, based on the comparison indicating that the first sensor values are different from the second sensor values for each of the plurality of sensors, performing one of: determining the Hall counter adjustment value for decreasing a Hall counter value by 2 based on the previous movement direction of the sunroof being an opening direction; or determining the Hall counter adjustment value for increasing the Hall counter value by 2 based on the previous movement direction of the sunroof being a closing direction.

Determining the adjustment value may include: based on the comparison indicating that the first sensor values are different from the second sensor values for each of the plurality of sensors, determining a Hall counter adjustment value further based on a spring tension direction of the sunroof.

Determining the adjustment value may further include: based on the comparison indicating that the first sensor values are different from the second sensor values for each of the plurality of sensors, determining the Hall counter adjustment value for decreasing a Hall counter value by 2 in the spring tension direction of the sunroof.

### SUMMARY

The present disclosure has been made to solve the above-mentioned problems occurring in the prior art while advantages achieved by the prior art are maintained intact.

An aspect of the present disclosure provides a vehicle control apparatus, which may prevent malfunction of a sunroof and may improve the safety and convenience of a user as a processor corrects a location change in a sunroof in a sleep mode based on a correction value calculated by comparing first sensor values received from a plurality of sensors in a wakeup mode before the sleep mode with second sensor values received from the plurality of sensors in the wakeup mode after the sleep mode, a system including the same, and a method thereof.

The technical problems to be solved by the present disclosure are not limited to the aforementioned problems, and any other technical problems not mentioned herein will be clearly understood from the following description by those skilled in the art to which the present disclosure pertains.

### BRIEF DESCRIPTION OF THE DRAWINGS

The above and other objects, features and advantages of the present disclosure will be more apparent from the following detailed description taken in conjunction with the accompanying drawings:

FIGS. 1 and 2 are block diagrams illustrating a configuration of a vehicle system including a vehicle control apparatus;

FIG. 3 is a block diagram showing a configuration of a vehicle control apparatus;

FIG. 4 is a drawing shows example Hall sensor values corresponding to motor rotation of a vehicle control apparatus;

FIG. 5 is a diagram showing example sensing signals of hall sensors corresponding to motor rotation of a vehicle control apparatus;

FIGS. 6 and 7 are diagrams showing Hall counter compensation values corresponding to a forward rotational direction of a motor in a vehicle control apparatus;

FIGS. 8 and 9 are diagrams showing Hall counter compensation values corresponding to a reverse rotational direction of a motor in a vehicle control apparatus;

FIGS. 10, 11, and 12 are diagrams showing Hall counter compensation values corresponding to motor rotation of a vehicle control apparatus;

FIG. 13 is a flowchart for describing a vehicle control method of a vehicle control apparatus; and

FIG. 14 shows an example computing system of a vehicle.

### DETAILED DESCRIPTION

Hereinafter, one or more example embodiments of the present disclosure will be described in detail with reference to the accompanying drawings. In adding reference numerals to components of each drawing, it should be noted that the same components include the same reference numerals, although they are indicated on another drawing. Furthermore, in describing the example embodiments of the present disclosure, detailed descriptions associated with well-known functions or configurations will be omitted when they may make subject matters of the present disclosure unnecessarily obscure.

In describing elements of one or more example embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

A sunroof, which may include glass and blinds, may be driven by a motor, and the sunroof may move while gears of the motor interlock cables of the sunroof mechanism.

Moreover, a controller may control the movement of the sunroof by controlling the rotation of the motor, and may estimate the movement direction and movement distance of the sunroof through a sensor.

However, the controller may detect the movement of the sunroof only when the controller is in the wake-up state, and the controller may not detect the movement of the sunroof when the controller is in the sleep state. Accordingly, when the controller controls the movement of the sunroof in the wake-up state, malfunction may occur in a sunroof device due to a change in the position of the sunroof when the sunroof moves when the controller is in the sleep state.

As such, when the change in a position of the sunroof is accumulated in the sleep state of the controller, the sunroof may not close, may be incorrectly reversed, or may cause injury to a user or cause discomfort to the user due to the increased reverse power.

Accordingly, in the future, the development of a vehicle control apparatus, which is capable of preventing malfunction of the sunroof by compensating for changes in the sunroof position in a sleep state of the controller and which improves the safety and convenience of a user, is required.

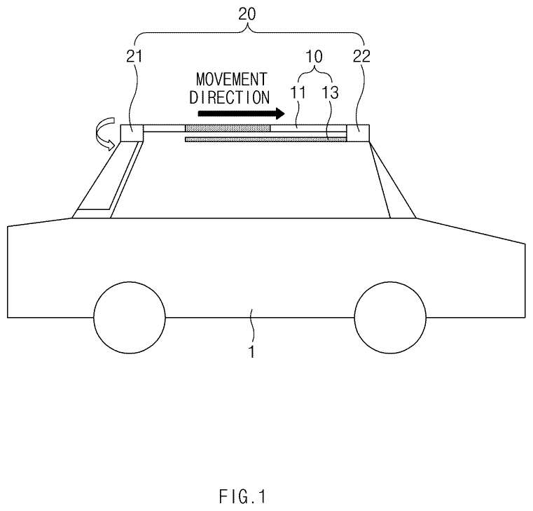

Hereinafter, various example embodiment(s) of the present disclosure will be described in detail with reference to FIGS. 1 to 14.

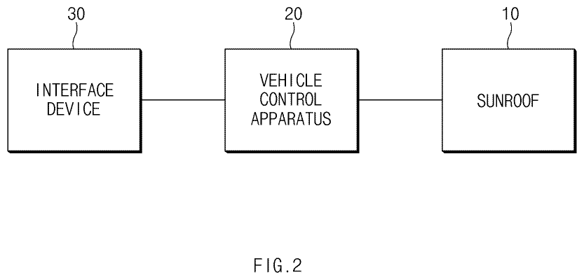

FIGS. 1 and 2 are block diagrams illustrating a configuration of a vehicle system including a vehicle control apparatus.

As shown in FIGS. 1 and 2, a vehicle system may include an interface device 30 for receiving a user command for operating a sunroof 10 located on an upper portion of a vehicle 1, and a vehicle control apparatus 20 including a motor and a plurality of sensors so as to control the movement of the sunroof 10 based on the user command.

Here, the vehicle control apparatus 20 may correct and control a sunroof position of the vehicle 1. However, the vehicle control apparatus 20 may also be applied to a vehicle configuration system capable of estimating a position of a specific object (also referred to as a location of the specific object) by using two Hall sensors (also referred to as Hall effect sensors) in addition to the sunroof to adjust (e.g., correct) and control the position of the specific object. The Hall sensors may be, for example, rotary Hall effect sensors.

For example, the specific object may include a window, a tailgate, a seat, a charging door, a glass curtain, a sliding door, a sunroof shade, or the like in addition to the sunroof.

For example, when the vehicle is continuously turned on/off while the tailgate and the sliding door are open during car camping or camping, a position may not be aligned. The vehicle control apparatus 20 may prevent the position from being misaligned by correcting and controlling the position of the specific object.

As shown in FIG. 1, the vehicle control apparatus 20 may include a first vehicle control apparatus 21 that controls movement of a glass (also referred as a moonroof) 11 of the sunroof 10, and a second vehicle control apparatus 22 that controls movement of a blind (also referred to as a sunroof cover, a sunroof panel, a sliding sunroof panel, etc.) 13 of the sunroof 10, and may individually control the glass 11 of the sunroof 10 and the blind 13 of the sunroof 10.

In some cases, the vehicle control apparatus 20 may simultaneously control the glass 11 of the sunroof 10 and the blind 13 of the sunroof 10 by integrating the glass 11 of the sunroof 10 and the blind 13 of the sunroof 10 into a single vehicle control apparatus.

The vehicle control apparatus 20 may include a motor for moving the sunroof 10 to open or close the sunroof 10, a plurality of sensors for detecting the rotation of the motor, memory for storing sensor values received from the sensors, and a processor for controlling the rotation of the motor based on the sensor values.

Here, when switching an operating mode of the vehicle control apparatus 20 from a sleep mode (also referred to as energy saving mode or low energy mode) to a wakeup mode (also referred to as normal energy mode, regular energy mode, or high energy mode), the vehicle control apparatus 20 may compare first sensor values received from a plurality of sensors in the wakeup mode before the sleep mode with second sensor values received from the plurality of sensors in the wakeup mode after the sleep mode. When the comparison result indicates that the first sensor values are different from the second sensor values, the vehicle control apparatus 20 may calculate a compensation value (also referred to an adjustment value or a calibration value) and may correct (e.g., adjust) the position of the sunroof 10 by controlling the rotation of the motor based on the calculated compensation value. In other words, the vehicle control apparatus 20 may store, for example, in the memory, first sensor values received from the plurality of sensors. The vehicle control apparatus 20 may store the first sensor values, for example, before a first time when the vehicle control apparatus switches from a wakeup mode to a sleep mode. The vehicle control apparatus 20 may compare the first sensor values stored in the memory with second sensor values. The vehicle control apparatus 20 may compare the first sensor values with second sensor values, for example, based on the vehicle control apparatus switching from the sleep mode (back) to the wakeup mode at a second time after the first time.

Moreover, when or after the sleep mode is switched to the wakeup mode when first sensor values are compared with second sensor values, the vehicle control apparatus 20 may receive the second sensor values from a plurality of sensors in the wakeup mode after the sleep mode, may retrieve, from the memory, the first sensor values stored during the wakeup mode before the sleep mode, and may compare the first sensor values and the second sensor values. The first sensor values and the second sensor values may correspond to the same time point. In other words, the first sensor values and the second sensor values are expected to correspond to each other (e.g., ideally the sensors values should be the same before and after the sleep mode), but during the sleep mode, the first sensor values and the second sensor values may become out of alignment.

Furthermore, if the comparison result indicates that one of the first sensor values is different from one of the second sensor values when the compensation value is calculated, the vehicle control apparatus 20 may calculate a Hall counter compensation value based on a type of edge that the different sensor values correspond to.

Here, the edge may refer to a time point where the sensor value changes from 0 to 1 or from 1 to 0. The time point changing from 0 to 1 may be a rising edge, and the time point changing from 1 to 0 may be a falling edge.

When the edge for different sensor values corresponds to a falling edge, the vehicle control apparatus 20 may calculate a Hall counter compensation value for increasing or decreasing the Hall counter value by 1 (e.g., an adjustment of the Hall counter value by 1). The Hall counter value may be a count measurement value as measured by a Hall effect sensor. When the edge for different sensor values corresponds to a rising edge, the vehicle control apparatus 20 may calculate a Hall counter compensation value for increasing or decreasing the Hall counter value by 1 (e.g., an adjustment of the Hall counter value by 1).

If the comparison result indicates that the first sensor values are completely different (e.g., a first sensor value from a first sensor is different from a second sensor value from a second sensor, and a second sensor value from the first sensor is also different from a second sensor value from the second sensor) from the second sensor values when the compensation value is calculated, the vehicle control apparatus 20 may calculate the Hall counter compensation value based on the previous movement direction of the glass 11 of the sunroof 10.

Here, the first sensor values and the second sensor values are completely different from each other (e.g., a first sensor value from a first sensor is different from a second sensor value from a second sensor, and a second sensor value from the first sensor is also different from a second sensor value from the second sensor), the vehicle control apparatus 20 may calculate a Hall counter compensation value for decreasing the Hall counter value by 2 when the previous movement direction of the glass 11 of the sunroof 10 is an opening direction (e.g., a rotational direction of the motor for the glass 11 that opens the glass 11), and may calculate a Hall counter compensation value for increasing the Hall counter value by 2 when the previous movement direction of the glass 11 of the sunroof 10 is a closing direction (e.g., a rotational direction of the motor for the glass 11 that closes the glass 11).

If the comparison result indicates that the first sensor values are completely different from the second sensor values (e.g., a first sensor value from a first sensor is different from a second sensor value from a second sensor, and a second sensor value from the first sensor is also different from a second sensor value from the second sensor) when the compensation value is calculated, the vehicle control apparatus 20 may calculate the Hall counter compensation value based on a spring tension direction of the blind 13.

Here, if the first sensor values and the second sensor values are completely different from each other (e.g., a first sensor value from a first sensor is different from a second sensor value from a second sensor, and a second sensor value from the first sensor is also different from a second sensor value from the second sensor), the vehicle control apparatus 20 may calculate a Hall counter compensation value for decreasing the Hall counter value by 2 in the same direction as the spring tension direction of the blind 13 of a sunroof.

As such, the present disclosure may prevent malfunction of a sunroof and may improve the safety and convenience of a user as a processor corrects (e.g., takes into account) a position change of a sunroof that might have taken place while the vehicle control apparatus was in a sleep mode, based on a correction value calculated by comparing first sensor values, received from a plurality of sensors in a wakeup mode before the sleep mode, with second sensor values received from the plurality of sensors in the wakeup mode after the sleep mode.

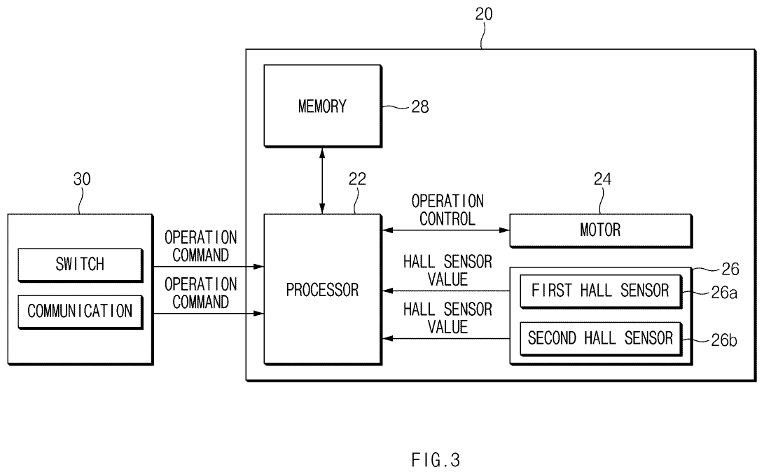

FIG. 3 is a block diagram showing a configuration of a vehicle control apparatus.

As illustrated in FIG. 3, the vehicle control apparatus 20 may include one or more motors 24 for moving a sunroof to open and close the sunroof, a plurality of sensors 26 for detecting the rotation of the one or more motors 24, memory 28 for storing sensor values received from the sensors 26, and a processor 22 for controlling the rotation of the one or more motors 24 based on the sensor values.

Here, the one or more motors 24 may include a first motor that moves the glass of the sunroof, and a second motor that moves the blind of the sunroof.

Moreover, the plurality of sensors 26 may include a first sensor including a pair of Hall sensors for detecting rotation of the first motor, and a pair of Hall sensors for detecting rotation of the second motor.

For example, each of the first sensor and the second sensor may include a pair of Hall sensors including a first Hall sensor 26a and a second Hall sensor 26b.

Here, a pair of Hall sensors corresponding to the first sensor may be placed side by side adjacent to one side of the first motor to output a sensing signal with a phase difference of 90 degrees by detecting the rotation of the first motor.

Furthermore, a pair of Hall sensors corresponding to the second sensor may be placed side by side adjacent to one side of the second motor to output a sensing signal with a phase difference of 90 degrees by detecting the rotation of the second motor.

The plurality of sensors 26 may include the first Hall sensor 26a and the second Hall sensor 26b, which are placed side by side while being adjacent to each other on one side of the one or more motors 24.

The first Hall sensor 26a may detect the rotation of the one or more motors 24 and then may output a first square wave signal, and the second Hall sensor 26b may detect the rotation of the one or more motors 24 and then may output a second square wave signal with a phase difference of 90 degrees with respect to the first square wave.

If an operating mode switches from a sleep mode to a wakeup mode, the processor 22 may compare first sensor values received from the plurality of sensors 26 in the wakeup mode before the sleep mode with second sensor values received from the plurality of sensors 26 in the wakeup mode after the sleep mode. When the comparison result indicates that the first sensor values are different from the second sensor values, the processor 22 may calculate a compensation value and may adjust (e.g., correct) the position of a sunroof by controlling the rotation of the one or more motors 24 based on the calculated compensation value.

Here, the processor 22 may store (e.g., write) sensor values, which are received from the plurality of sensors 26 in the memory 28 during the wakeup mode, and then may stop storing sensor values (e.g., stop writing any new or additional sensor values) during the sleep mode.

For example, when storing the sensor values, the processor 22 may store the sensor values including a first Hall sensor value and a second Hall sensor value according to the rotation of the one or more motors 24 in the memory 28 based on a first square wave output from the first Hall sensor 26a and a second square wave output from the second Hall sensor 26b among the plurality of sensors 26.

Here, whenever an edge occurs in the first Hall sensor value and the second Hall sensor value, the processor 22 may increase or decrease the Hall counter value and may estimate the rotation speed of the motor and the position of a sunroof based on the Hall counter value.

That is, when the one or more motors 24 rotate in a forward direction (e.g., a first rotational direction), the processor 22 may increase the Hall counter value by 1 whenever an edge occurs. When the one or more motors 24 rotate in a reverse direction (e.g., a second rotational direction), the processor 22 may decrease the Hall counter value by 1 whenever an edge occurs. The forward direction and the reverse direction of the motor do not necessarily denote that one direction is preferred over another and may be referred to as a first rotational direction (or a first direction) and a second rotational direction (or a second direction).

If the operation mode switches from the sleep mode to the wakeup mode, the processor 22 may receive the second sensor values from the plurality of sensors 26 in the wakeup mode (e.g., after the sleep mode), may retrieve the first sensor values stored in the wakeup mode before the sleep mode from the memory 28, and may compare the first sensor values and the second sensor values. The first sensor values and the second sensor values may correspond to the same time point. In other words, the first sensor values and the second sensor values are expected to correspond to each other (e.g., ideally the sensors values should be the same before and after the sleep mode), but during the sleep mode, the first sensor values and the second sensor values may become out of alignment.

Here, the processor 22 may identify a current rotation direction of the one or more motors 24 if the operation mode (e.g., of the vehicle control apparatus) switches from the sleep mode to the wakeup mode, and may retrieve a first sensor value, which was received when the one or more motors 24 were rotating in the forward direction (e.g., a first rotational direction), from among the first sensor values stored in the wakeup mode before the sleep mode from the memory 28 when the current rotation direction of the one or more motors 24 is a forward direction.

For example, the processor 22 may identify a current rotation direction of the one or more motors 24 if the operation mode switches from the sleep mode to the wakeup mode, and may retrieve a first sensor value, which was received when the one or more motors 24 were rotating in the reverse direction (e.g., a second rotational direction), from among the first sensor values stored in the wakeup mode before the sleep mode from the memory 28 when a current rotation direction of the one or more motors 24 is a reverse direction.

If the comparison result indicates that one of the first sensor values is different from one of the second sensor values when the compensation value is calculated, the processor 22 may calculate a Hall counter compensation value (also referred to as a Hall counter adjustment value) based on an edge (e.g., a type of the edge) corresponding to the different sensor values.

If the edge for different sensor values is a falling edge, the processor 22 may calculate a Hall counter compensation value for increasing or decreasing the Hall counter value by 1 (e.g., an adjustment of the Hall counter value by 1). If the edge for different sensor values is a rising edge, the processor 22 may calculate a Hall counter compensation value for increasing or decreasing the Hall counter value by 1 (e.g., an adjustment of the Hall counter value by 1).

For example, if a first Hall sensor value among the first sensor values is high and a second Hall sensor value among the first sensor values is low, the processor 22 may calculate a Hall counter compensation value for decreasing the Hall counter value by 1 if a first Hall sensor value among the second sensor values is low, and a second Hall sensor value among the second sensor values is low, and an edge for the changed first Hall sensor value is a falling edge, and may calculate a Hall counter compensation value for increasing the Hall counter value by 1 if the first Hall sensor value among the second sensor values is high, the second Hall sensor value among the second sensor values is high, and the edge for the changed second Hall sensor value is a rising edge.

Moreover, if a first Hall sensor value among the first sensor values is high and a second Hall sensor value among the first sensor values is high, the processor 22 may calculate a Hall counter compensation value for decreasing the Hall counter value by 1 if a first Hall sensor value among the second sensor values is high, and a second Hall sensor value among the second sensor values is low, and an edge for the changed second Hall sensor value is a falling edge, and may calculate a Hall counter compensation value for increasing the Hall counter value by 1 if the first Hall sensor value among the second sensor values is low, the second Hall sensor value among the second sensor values is high, and the edge for the changed first Hall sensor value is a falling edge.

Furthermore, if a first Hall sensor value among the first sensor values is low and a second Hall sensor value among the first sensor values is high, the processor 22 may calculate a Hall counter compensation value for decreasing the Hall counter value by 1 if a first Hall sensor value among the second sensor values is high, and a second Hall sensor value among the second sensor values is high, and an edge for the changed first Hall sensor value is a rising edge, and may calculate a Hall counter compensation value for increasing the Hall counter value by 1 if the first Hall sensor value among the second sensor values is low, the second Hall sensor value among the second sensor values is low, and the edge for the changed second Hall sensor value is a falling edge.

If a first Hall sensor value among the first sensor values is low and a second Hall sensor value among the first sensor values is low, the processor 22 may calculate a Hall counter compensation value for decreasing the Hall counter value by 1 if a first Hall sensor value among the second sensor values is low, and a second Hall sensor value among the second sensor values is high, and an edge for the changed second Hall sensor value is a rising edge, and may calculate a Hall counter compensation value for increasing the Hall counter value by 1 if the first Hall sensor value among the second sensor values is high, the second Hall sensor value among the second sensor values is low, and the edge for the changed first Hall sensor value is a rising edge.

Also, the processor 22 may calculate a Hall counter compensation value calculated if the rotation direction of the one or more motors 24 is a forward direction and a Hall counter compensation value calculated if the rotation direction of the one or more motors 24 is a reverse direction so as to be identical to each other.

In some cases, if the comparison result indicates that the first sensor values are completely different from the second sensor values (e.g., a first sensor value from a first sensor is different from a second sensor value from a second sensor, and a second sensor value from the first sensor is also different from a second sensor value from the second sensor) when the compensation value is calculated, the processor 22 may calculate the Hall counter compensation value based on the previous movement direction of the sunroof.

If the first sensor values and the second sensor values are completely different from each other (e.g., a first sensor value from a first sensor is different from a second sensor value from a second sensor, and a second sensor value from the first sensor is also different from a second sensor value from the second sensor), the processor 22 may calculate a Hall counter compensation value for decreasing the Hall counter value by 2 if the previous movement direction of the sunroof is an opening direction, and may calculate a Hall counter compensation value for increasing the Hall counter value by 2 if the previous movement direction of the sunroof is a closing direction.

In this case, the processor 22 may open or close the glass of the sunroof by applying a Hall counter compensation value for decreasing or increasing a Hall counter value by 2 to a first motor that moves the glass of the sunroof.

For example, if a first Hall sensor value among the first sensor values is high, a second Hall sensor value among the first sensor values is low, a first Hall sensor value among the second sensor values is low, and a second Hall sensor value among the second sensor values is high, the processor 22 may calculate a Hall counter compensation value for decreasing the Hall counter value by 2 if the previous movement direction of the sunroof is an opening direction, and may calculate a Hall counter compensation value for increasing the Hall counter value by 2 if the previous movement direction of the sunroof is a closing direction.

Moreover, if a first Hall sensor value among the first sensor values is high, a second Hall sensor value among the first sensor values is high, a first Hall sensor value among the second sensor values is low, and a second Hall sensor value among the second sensor values is low, the processor 22 may calculate a Hall counter compensation value for decreasing the Hall counter value by 2 if the previous movement direction of the sunroof is an opening direction, and may calculate a Hall counter compensation value for increasing the Hall counter value by 2 if the previous movement direction of the sunroof is a closing direction.

Moreover, if a first Hall sensor value among the first sensor values is low, a second Hall sensor value among the first sensor values is high, a first Hall sensor value among the second sensor values is high, and a second Hall sensor value among the second sensor values is low, the processor 22 may calculate a Hall counter compensation value for decreasing the Hall counter value by 2 if the previous movement direction of the sunroof is an opening direction, and may calculate a Hall counter compensation value for increasing the Hall counter value by 2 if the previous movement direction of the sunroof is a closing direction.

Moreover, if a first Hall sensor value among the first sensor values is low, a second Hall sensor value among the first sensor values is low, a first Hall sensor value among the second sensor values is high, and a second Hall sensor value among the second sensor values is high, the processor 22 may calculate a Hall counter compensation value for decreasing the Hall counter value by 2 if the previous movement direction of the sunroof is an opening direction, and may calculate a Hall counter compensation value for increasing the Hall counter value by 2 if the previous movement direction of the sunroof is a closing direction.

In other cases, if the comparison result indicates that the first sensor values are completely different from the second sensor values (e.g., a first sensor value from a first sensor is different from a second sensor value from a second sensor, and a second sensor value from the first sensor is also different from a second sensor value from the second sensor) when the compensation value is calculated, the processor 22 may calculate the Hall counter compensation value based on a spring tension direction of the sunroof.

If the first sensor values and the second sensor values are completely different from each other (e.g., a first sensor value from a first sensor is different from a second sensor value from a second sensor, and a second sensor value from the first sensor is also different from a second sensor value from the second sensor), the processor 22 may calculate a Hall counter compensation value for decreasing the Hall counter value by 2 in the same direction as the spring tension direction of the sunroof.

In this case, the processor 22 may open or close the blind of the sunroof by applying a Hall counter compensation value for decreasing a Hall counter value by 2 to a second motor that moves the blind of the sunroof.

For example, if a first Hall sensor value among the first sensor values is high, a second Hall sensor value among the first sensor values is low, a first Hall sensor value among the second sensor values is low, and a second Hall sensor value among the second sensor values is high, the processor 22 may calculate a Hall counter compensation value for decreasing the Hall counter value by 2 in the same direction as the spring tension direction of the sunroof.

Moreover, if a first Hall sensor value among the first sensor values is high, a second Hall sensor value among the first sensor values is high, a first Hall sensor value among the second sensor values is low, and a second Hall sensor value among the second sensor values is low, the processor 22 may calculate a Hall counter compensation value for decreasing the Hall counter value by 2 in the same direction as the spring tension direction of the sunroof.

Moreover, if a first Hall sensor value among the first sensor values is low, a second Hall sensor value among the first sensor values is high, a first Hall sensor value among the second sensor values is high, and a second Hall sensor value among the second sensor values is low, the processor 22 may calculate a Hall counter compensation value for decreasing the Hall counter value by 2 in the same direction as the spring tension direction of the sunroof.

Moreover, if a first Hall sensor value among the first sensor values is low, a second Hall sensor value among the first sensor values is low, a first Hall sensor value among the second sensor values is high, and a second Hall sensor value among the second sensor values is high, the processor 22 may calculate a Hall counter compensation value for decreasing the Hall counter value by 2 in the same direction as the spring tension direction of the sunroof.

Next, the processor 22 may receive a user's operation command for sunroof operation through a user's switch operation or the interface device 30 in a wired/wireless communication scheme, and may correct and control the movement of the sunroof of a vehicle based on the user's operation command.

As such, the present disclosure may prevent malfunction of a sunroof and may improve the safety and convenience of a user as a processor corrects a position change in a sunroof in a sleep mode based on a correction value calculated by comparing first sensor values received from a plurality of sensors in a wakeup mode before the sleep mode with second sensor values received from the plurality of sensors in the wakeup mode after the sleep mode.

Moreover, the present disclosure may prevent closing and opening failures caused by accumulated changes in a sunroof position.

Furthermore, the present disclosure may prevent a situation in which the sunroof is incorrectly closed due to incorrect learning load usage caused by incorrectly determining the sunroof position, and may prevent bodily injury caused by an increase in reverse power if a user's body part (e.g., fingers) gets caught or jammed.

The present disclosure may prevent or alleviate sunroof cable wear and motor deterioration by preventing excessive initialization for sunroof position correction.

Also, the present disclosure may be applied to any vehicle part, other than the sunroof, that requires estimation and correction of a position by using two or more Hall sensors, such as a window, a tailgate, a seat, a charging door, a glass curtain, a sliding door, and the like.

For example, when a vehicle is continuously turned on/off while the tailgate and the sliding door are open during car camping or camping, a position may not be aligned. Accordingly, the misalignment of a position may be prevented by applying the present disclosure.

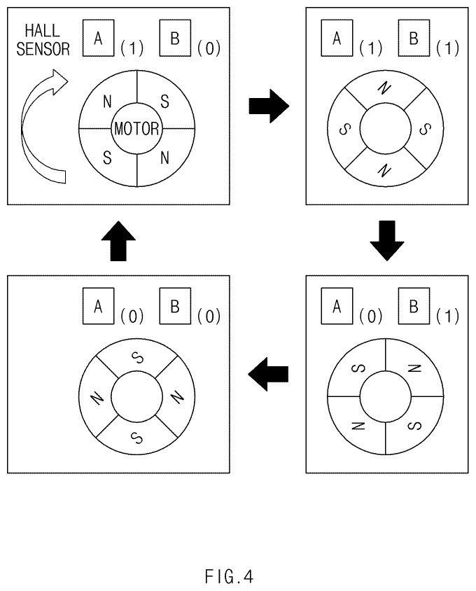

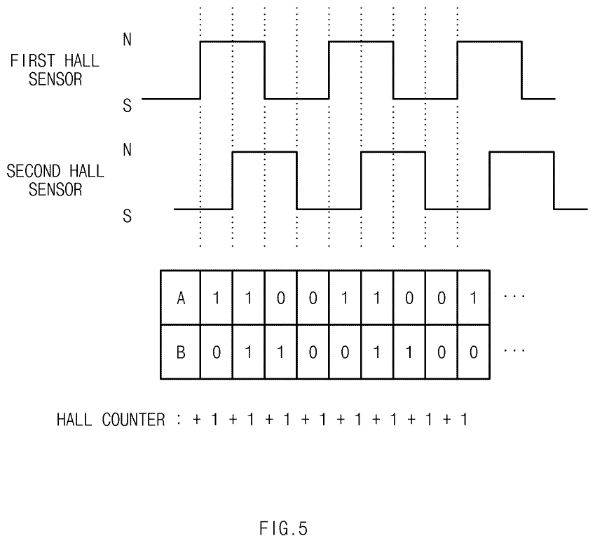

FIG. 4 shows example Hall sensor values corresponding to motor rotation of a vehicle control apparatus. FIG. 5 is a diagram showing example sensing signals of Hall sensors corresponding to motor rotation of a vehicle control apparatus.

As shown in FIGS. 4 and 5, a vehicle control apparatus for controlling a sunroof is equipped with two Hall sensors A and B. Whenever a motor rotates, a specific signal pattern may be created depending on a rotation direction.

On the basis of the corresponding signal pattern, the vehicle control apparatus of the present disclosure may detect a forward direction rotation of a motor, may detect a reverse direction rotation of the motor, and may determine whether the motor operates normally.

Moreover, the vehicle control apparatus of the present disclosure may estimate the number of motor rotations and the actual position of a sunroof system by increasing or decreasing a Hall counter value whenever a polar change of the Hall sensor occurs.

Here, even when a polar count (2 poles, 4 poles, 8 poles, or the like) of the motor changes and a Hall sensor position changes, the present disclosure is capable of being applied.

As such, the vehicle control apparatus of the present disclosure may include a motor for moving the sunroof to open and close the sunroof, and a plurality of sensors for detecting rotation of the motor.

Here, the plurality of sensors may include a first Hall sensor A and a second Hall sensor B, which are placed side by side while being adjacent to each other on one side of the motor.

Here, the first Hall sensor A may detect the rotation of the motor and then may output a first square wave, and the second Hall sensor B may detect the rotation of the motor and then may output the second square wave with a phase difference of 90 degrees with respect to the first square wave.

The vehicle control apparatus of the present disclosure may store sensor values received from the first Hall sensor A and the second Hall sensor B in memory in a wakeup mode, and may stop storing the sensor values during the sleep mode.

For example, the vehicle control apparatus of the present disclosure may store the sensor values including a first Hall sensor value and a second Hall sensor value according to the rotation of the motor in the memory based on the first square wave output from the first Hall sensor A and the second square wave output from the second Hall sensor among the plurality of sensors.

Here, whenever an edge occurs in the first Hall sensor value and the second Hall sensor value, the vehicle control apparatus of the present disclosure may increase or decrease the Hall counter value and may estimate the rotation speed of the motor and the position of a sunroof based on the Hall counter value.

That is, when the motor rotates in a forward direction, the vehicle control apparatus of the present disclosure may increase the Hall counter value by 1 whenever an edge occurs. When the motor rotates in a reverse direction, the vehicle control apparatus of the present disclosure may decrease the Hall counter value by 1 whenever an edge occurs.

Here, the edge means a time point where the sensor value changes from 0 to 1 or from 1 to 0. The time point changing from 0 to 1 may be a rising edge, and the time point changing from 1 to 0 may be a falling edge.

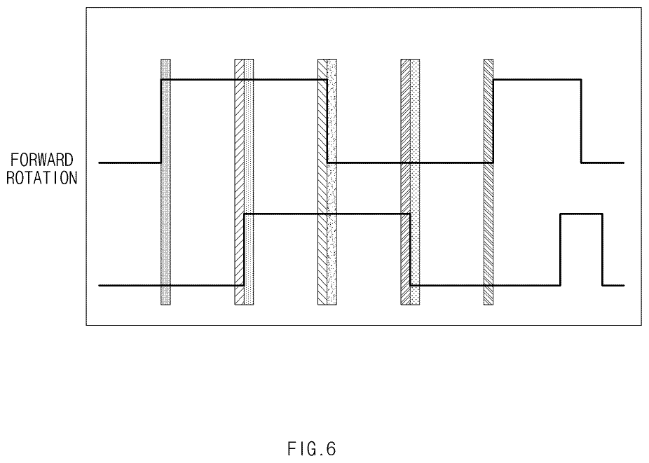

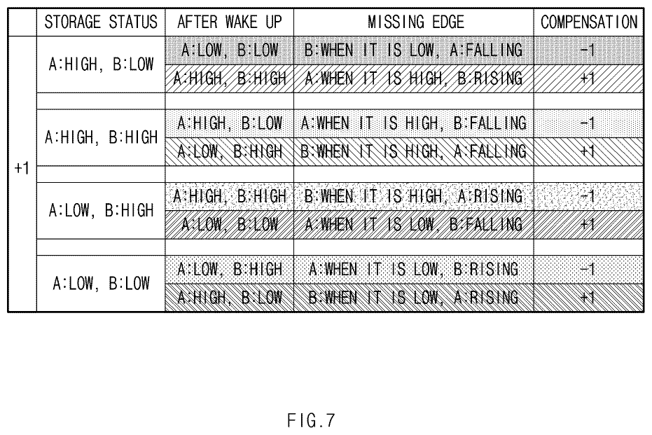

FIGS. 6 and 7 are diagrams showing Hall counter compensation values corresponding to a forward rotational direction of a motor of a vehicle control apparatus.

As shown in FIGS. 6 and 7, in a wakeup mode, the present disclosure may store sensor values received from first and second Hall sensors in memory.

For example, the present disclosure may store the sensor values including a first Hall sensor value and a second Hall sensor value according to the rotation of the motor in the memory based on the first square wave output from the first Hall sensor A and the second square wave output from the second Hall sensor among the plurality of sensors.

Next, when a sleep mode is switched to the wakeup mode, the present disclosure may receive the second sensor values from the first and second sensors in the wakeup mode after the sleep mode, may retrieve the first sensor values stored in the wakeup mode before the sleep mode from the memory, and may compare the first sensor value and the second sensor value, which correspond to the same time point.

Here, the present disclosure may identify a current rotation direction of the motor when the sleep mode is switching to the wakeup mode, and may retrieve a first sensor value, which is received when the motor rotates in the forward direction, from among the first sensor values stored in the wakeup mode before the sleep mode from the memory when the current rotation direction of the motor is the forward direction.

Then, when the comparison result indicates that one of the first sensor values is different from one of the second sensor values, the present disclosure may calculate a Hall counter compensation value (also referred to as a Hall counter adjustment value or an adjustment value) based on an edge for different sensor values.

Here, when the edge for different sensor values is a falling edge, the present disclosure may calculate a Hall counter compensation value for increasing or decreasing the Hall counter value by 1 (e.g., an adjustment of the Hall counter value by 1). When the edge for different sensor values is a rising edge, the present disclosure may calculate a Hall counter compensation value for increasing or decreasing the Hall counter value by 1 (e.g., an adjustment of the Hall counter value by 1).

For example, as illustrated in FIG. 7, when a first Hall sensor value among the first sensor values, which are stored in the wakeup mode before the sleep mode, is high and a second Hall sensor value among the first sensor values is low, the present disclosure may calculate a Hall counter compensation value for decreasing the Hall counter value by 1 when a first Hall sensor value among the second sensor values, which are measured stored in the wakeup mode after the sleep mode, is low, and a second Hall sensor value among the second sensor values is low, and an edge for the changed first Hall sensor value is a falling edge, and may calculate a Hall counter compensation value for increasing the Hall counter value by 1 when the first Hall sensor value among the second sensor values is high, the second Hall sensor value among the second sensor values is high, and the edge for the changed second Hall sensor value is a rising edge.

Moreover, as illustrated in FIG. 7, when a first Hall sensor value among the first sensor values is high and a second Hall sensor value among the first sensor values is high, the present disclosure may calculate a Hall counter compensation value for decreasing the Hall counter value by 1 when a first Hall sensor value among the second sensor values is high, and a second Hall sensor value among the second sensor values is low, and an edge for the changed second Hall sensor value is a falling edge, and may calculate a Hall counter compensation value for increasing the Hall counter value by 1 when the first Hall sensor value among the second sensor values is low, the second Hall sensor value among the second sensor values is high, and the edge for the changed first Hall sensor value is a falling edge.

Furthermore, as illustrated in FIG. 7, when a first Hall sensor value among the first sensor values is low and a second Hall sensor value among the first sensor values is high, the present disclosure may calculate a Hall counter compensation value for decreasing the Hall counter value by 1 when a first Hall sensor value among the second sensor values is high, and a second Hall sensor value among the second sensor values is high, and an edge for the changed first Hall sensor value is a rising edge, and may calculate a Hall counter compensation value for increasing the Hall counter value by 1 when the first Hall sensor value among the second sensor values is low, the second Hall sensor value among the second sensor values is low, and the edge for the changed second Hall sensor value is a falling edge.

Besides, as illustrated in FIG. 7, when a first Hall sensor value among the first sensor values is low and a second Hall sensor value among the first sensor values is low, the present disclosure may calculate a Hall counter compensation value for decreasing the Hall counter value by 1 when a first Hall sensor value among the second sensor values is low, and a second Hall sensor value among the second sensor values is high, and an edge for the changed second Hall sensor value is a rising edge, and may calculate a Hall counter compensation value for increasing the Hall counter value by 1 when the first Hall sensor value among the second sensor values is high, the second Hall sensor value among the second sensor values is low, and the edge for the changed first Hall sensor value is a rising edge.

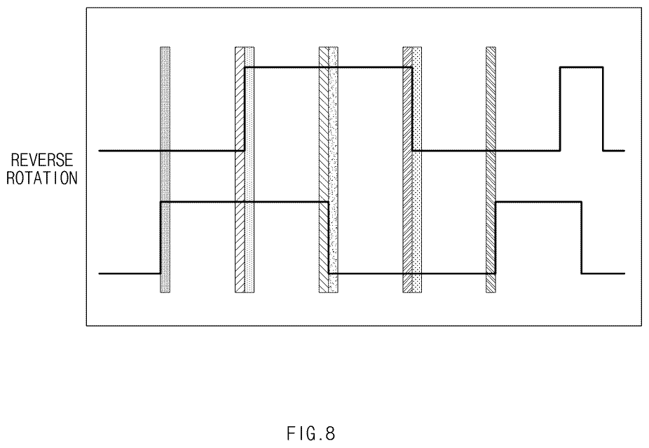

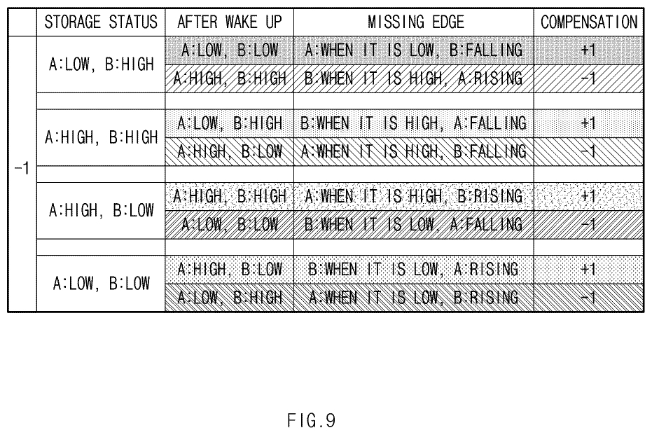

FIGS. 8 and 9 are diagrams showing Hall counter compensation values corresponding to a reverse rotational direction of a motor in a vehicle control apparatus.

As illustrated in FIGS. 8 and 9, the present disclosure may identify a current rotation direction of a motor when a sleep mode is switching to a wakeup mode, and may retrieve a first sensor value, which is received when the motor rotates in a reverse direction, from among first sensor values stored in the wakeup mode before the sleep mode from memory when the current rotation direction of the motor is the reverse direction.

Then, when the comparison result indicates that one of the first sensor values is different from one of the second sensor values, the present disclosure may calculate a Hall counter compensation value based on an edge for different sensor values.

Here, when the edge for different sensor values is a falling edge, the present disclosure may calculate a Hall counter compensation value for increasing or decreasing the Hall counter value by 1 (e.g., an adjustment of the Hall counter value by 1). When the edge for different sensor values is a rising edge, the present disclosure may calculate a Hall counter compensation value for increasing or decreasing the Hall counter value by 1 (e.g., an adjustment of the Hall counter value by 1).

Furthermore, as illustrated in FIG. 9, when a first Hall sensor value among the first sensor values, which are stored in the wakeup mode before the sleep mode, is low and a second Hall sensor value among the first sensor values is high, the present disclosure may calculate a Hall counter compensation value for decreasing the Hall counter value by 1 when a first Hall sensor value among the second sensor values, which are measured stored in the wakeup mode after the sleep mode, is high, and a second Hall sensor value among the second sensor values is high, and an edge for the changed first Hall sensor value is a rising edge, and may calculate a Hall counter compensation value for increasing the Hall counter value by 1 when the first Hall sensor value among the second sensor values is low, the second Hall sensor value among the second sensor values is low, and the edge for the changed second Hall sensor value is a falling edge.

Moreover, as illustrated in FIG. 9, when a first Hall sensor value among the first sensor values is high and a second Hall sensor value among the first sensor values is high, the present disclosure may calculate a Hall counter compensation value for decreasing the Hall counter value by 1 when a first Hall sensor value among the second sensor values is high, and a second Hall sensor value among the second sensor values is low, and an edge for the changed second Hall sensor value is a falling edge, and may calculate a Hall counter compensation value for increasing the Hall counter value by 1 when the first Hall sensor value among the second sensor values is low, the second Hall sensor value among the second sensor values is high, and the edge for the changed first Hall sensor value is a falling edge.

Furthermore, as illustrated in FIG. 9, when a first Hall sensor value among the first sensor values is high and a second Hall sensor value among the first sensor values is low, the present disclosure may calculate a Hall counter compensation value for decreasing the Hall counter value by 1 when a first Hall sensor value among the second sensor values is low, and a second Hall sensor value among the second sensor values is low, and an edge for the changed first Hall sensor value is a falling edge, and may calculate a Hall counter compensation value for increasing the Hall counter value by 1 when the first Hall sensor value among the second sensor values is high, the second Hall sensor value among the second sensor values is high, and the edge for the changed second Hall sensor value is a rising edge.

Besides, as illustrated in FIG. 9, when a first Hall sensor value among the first sensor values is low and a second Hall sensor value among the first sensor values is low, the present disclosure may calculate a Hall counter compensation value for decreasing the Hall counter value by 1 when a first Hall sensor value among the second sensor values is low, and a second Hall sensor value among the second sensor values is high, and an edge for the changed second Hall sensor value is a rising edge, and may calculate a Hall counter compensation value for increasing the Hall counter value by 1 when the first Hall sensor value among the second sensor values is high, the second Hall sensor value among the second sensor values is low, and the edge for the changed first Hall sensor value is a rising edge.

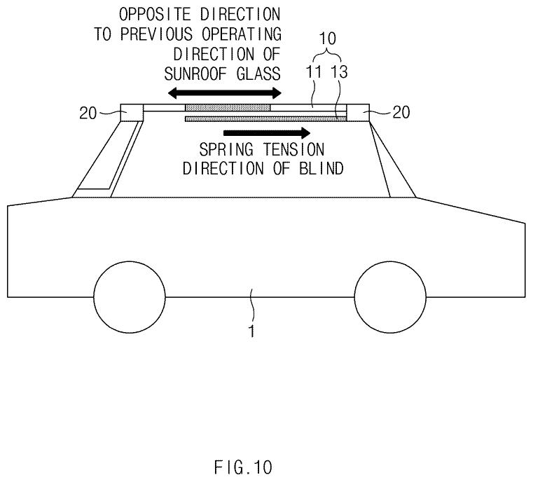

FIGS. 10 to 12 are diagrams showing Hall counter compensation values corresponding to motor rotation of a vehicle control apparatus.

As shown in FIGS. 10 to 12, because it is impossible to estimate a forward direction rotation and a reverse direction rotation of a motor when all of the second sensing values of the first Hall sensor A and the second Hall sensor B, which are measured in a wakeup mode after a sleep mode are changed compared to first sensor values stored in the wakeup mode before the sleep mode, the present disclosure may estimate and compensate for them depending on systematical characteristics.

For example, the blind 13 of the sunroof 10 moves only in a (−) direction due to spring tension, and thus a Hall counter compensation value may be calculated to comp©

Moreover, the glass 11 of the sunroof 10 may move only in the opposite direction to the previous operating direction due to the reaction force of the glass movement and the cable tension, and thus the Hall counter compensation value may be calculated to compensate for the Hall counter compensation value by +2 or −2 by estimating the compensation in the opposite direction due to the reaction due to glass inertia and cable tension based on the previous operating direction.

In general, the movement of the glass 11 and the blind 13 of the sunroof 10 due to external force may be set not to exceed 2 ticks by motor restraint torque.

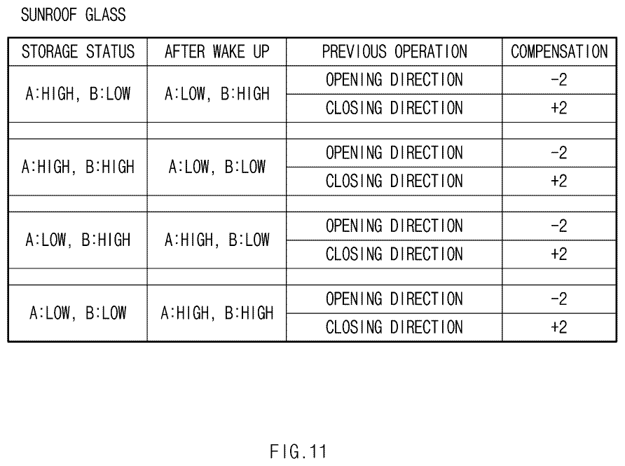

As such, as illustrated in FIG. 11, when the comparison result indicates that the first sensor values stored in the wakeup mode before the sleep mode are completely different from the second sensor values (e.g., a first sensor value from a first sensor is different from a second sensor value from a second sensor, and a second sensor value from the first sensor is also different from a second sensor value from the second sensor) measured in the wakeup mode after the sleep mode, the present disclosure may calculate the Hall counter compensation value based on the previous movement direction of the sunroof.

Here, when the first sensor values and the second sensor values are completely different from each other (e.g., a first sensor value from a first sensor is different from a second sensor value from a second sensor, and a second sensor value from the first sensor is also different from a second sensor value from the second sensor), the present disclosure may calculate a Hall counter compensation value for decreasing the Hall counter value by 2 when the previous movement direction of the sunroof is an opening direction, and may calculate a Hall counter compensation value for increasing the Hall counter value by 2 when the previous movement direction of the sunroof is a closing direction.

In this case, the present disclosure may open and close the glass 11 of the sunroof 10 by applying a Hall counter compensation value for decreasing or increasing the Hall counter value by 2 to a first motor that moves the glass 11 of the sunroof 10.

For example, as illustrated in FIG. 11, when a first Hall sensor value among the first sensor values, which are stored in the wakeup mode before the sleep mode, is high, a second Hall sensor value among the first sensor values is low, a first Hall sensor value among the second sensor values, which are measured stored in the wakeup mode after the sleep mode, is low, and a second Hall sensor value among the second sensor values is high, the present disclosure may calculate a Hall counter compensation value for decreasing the Hall counter value by 2 when the previous movement direction of the sunroof is an opening direction, and may calculate a Hall counter compensation value for increasing the Hall counter value by 2 when the previous movement direction of the sunroof is a closing direction.

Moreover, when a first Hall sensor value among the first sensor values is high, a second Hall sensor value among the first sensor values is high, a first Hall sensor value among the second sensor values is low, and a second Hall sensor value among the second sensor values is low, the present disclosure may calculate a Hall counter compensation value for decreasing the Hall counter value by 2 when the previous movement direction of the sunroof is an opening direction, and may calculate a Hall counter compensation value for increasing the Hall counter value by 2 when the previous movement direction of the sunroof is a closing direction.

Moreover, when a first Hall sensor value among the first sensor values is low, a second Hall sensor value among the first sensor values is high, a first Hall sensor value among the second sensor values is high, and a second Hall sensor value among the second sensor values is low, the present disclosure may calculate a Hall counter compensation value for decreasing the Hall counter value by 2 when the previous movement direction of the sunroof is an opening direction, and may calculate a Hall counter compensation value for increasing the Hall counter value by 2 when the previous movement direction of the sunroof is a closing direction.

Moreover, when a first Hall sensor value among the first sensor values is low, a second Hall sensor value among the first sensor values is low, a first Hall sensor value among the second sensor values is high, and a second Hall sensor value among the second sensor values is high, the present disclosure may calculate a Hall counter compensation value for decreasing the Hall counter value by 2 when the previous movement direction of the sunroof is an opening direction, and may calculate a Hall counter compensation value for increasing the Hall counter value by 2 when the previous movement direction of the sunroof is a closing direction.

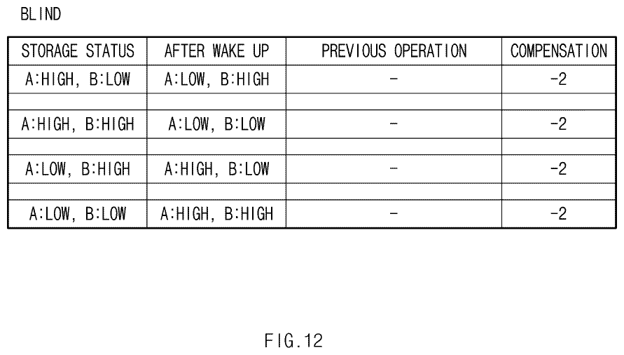

In other cases, as illustrated in FIG. 12, when the comparison result indicates that the first sensor values stored in the wakeup mode before the sleep mode are completely different from the second sensor values (e.g., a first sensor value from a first sensor is different from a second sensor value from a second sensor, and a second sensor value from the first sensor is also different from a second sensor value from the second sensor) measured in the wakeup mode after the sleep mode, the present disclosure may calculate the Hall counter compensation value based on the spring tension direction of the sunroof.

Here, when the first sensor values and the second sensor values are completely different from each other (e.g., a first sensor value from a first sensor is different from a second sensor value from a second sensor, and a second sensor value from the first sensor is also different from a second sensor value from the second sensor), the present disclosure may calculate a Hall counter compensation value for decreasing the Hall counter value by 2 in the same direction as the spring tension direction of the sunroof.

In this case, the present disclosure may open and close the blind 13 of the sunroof 10 by applying a Hall counter compensation value for decreasing the Hall counter value by 2 to a second motor that moves the blind 13 of the sunroof 10.

For example, as illustrated in FIG. 12, when a first Hall sensor value among the first sensor values, which are stored in the wakeup mode before the sleep mode, is high, a second Hall sensor value among the first sensor values is low, a first Hall sensor value among the second sensor values, which are measured stored in the wakeup mode after the sleep mode, is low, and a second Hall sensor value among the second sensor values is high, the present disclosure may calculate the Hall counter compensation value for decreasing the Hall counter value by 2 in the same direction as the spring tension direction of the sunroof.

Moreover, when a first Hall sensor value among the first sensor values is high, a second Hall sensor value among the first sensor values is high, a first Hall sensor value among the second sensor values is low, and a second Hall sensor value among the second sensor values is low, the present disclosure may calculate a Hall counter compensation value for decreasing the Hall counter value by 2 in the same direction as the spring tension direction of the sunroof.

Moreover, when a first Hall sensor value among the first sensor values is low, a second Hall sensor value among the first sensor values is high, a first Hall sensor value among the second sensor values is high, and a second Hall sensor value among the second sensor values is low, the present disclosure may calculate a Hall counter compensation value for decreasing the Hall counter value by 2 in the same direction as the spring tension direction of the sunroof.

Moreover, when a first Hall sensor value among the first sensor values is low, a second Hall sensor value among the first sensor values is low, a first Hall sensor value among the second sensor values is high, and a second Hall sensor value among the second sensor values is high, the present disclosure may calculate a Hall counter compensation value for decreasing the Hall counter value by 2 in the same direction as the spring tension direction of the sunroof.

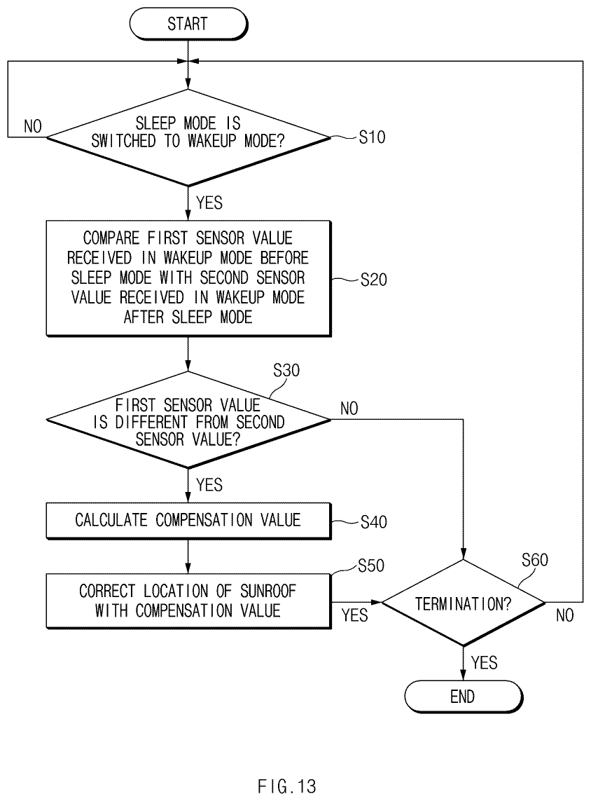

FIG. 13 is a flowchart for describing a vehicle control method of a vehicle control apparatus.

As shown in FIG. 13, the present disclosure may determine whether a sleep mode is switched to a wakeup mode (S10).

Next, when the sleep mode is switched to the wakeup mode, the present disclosure may compare first sensor values received from a plurality of sensors in the wakeup mode before the sleep mode with second sensor values received from the plurality of sensors in the wakeup mode after the sleep mode (S20).

Next, the present disclosure may determine whether the first sensor values and the second sensor values are different from each other (S30).

Moreover, the present disclosure may calculate a compensation value when the first sensor values are different from the second sensor values (S40).

Here, when one of the first sensor values is different from one of the second sensor values, the present disclosure may calculate a Hall counter compensation value based on an edge for different sensor values.

For example, when the edge for different sensor values is a falling edge, the present disclosure may calculate a Hall counter compensation value for increasing or decreasing the Hall counter value by 1 (e.g., an adjustment of the Hall counter value by 1). When the edge for different sensor values is a rising edge, the present disclosure may calculate a Hall counter compensation value for increasing or decreasing the Hall counter value by 1 (e.g., an adjustment of the hall counter value by 1).

In some cases, when the first sensor values are completely different from the second sensor values (e.g., a first sensor value from a first sensor is different from a second sensor value from a second sensor, and a second sensor value from the first sensor is also different from a second sensor value from the second sensor), the present disclosure may calculate the Hall counter compensation value based on the previous movement direction of the sunroof (e.g., the last known direction of movement of the sunroof).

Here, when the first sensor values and the second sensor values are completely different from each other (e.g., a first sensor value from a first sensor is different from a second sensor value from a second sensor, and a second sensor value from the first sensor is also different from a second sensor value from the second sensor), the present disclosure may calculate a Hall counter compensation value for decreasing the Hall counter value by 2 when the previous movement direction of the sunroof is an opening direction, and may calculate a Hall counter compensation value for increasing the Hall counter value by 2 when the previous movement direction of the sunroof is a closing direction.

For example, the present disclosure may open or close the glass of the sunroof by applying a Hall counter compensation value for decreasing or increasing a Hall counter value by 2 to a first motor that moves the glass of the sunroof.

In other cases, when the first sensor values are completely different from the second sensor values (e.g., a first sensor value from a first sensor is different from a second sensor value from a second sensor, and a second sensor value from the first sensor is also different from a second sensor value from the second sensor), the present disclosure may calculate the Hall counter compensation value based on a spring tension direction of the sunroof.

Here, when the first sensor values and the second sensor values are completely different from each other (e.g., a first sensor value from a first sensor is different from a second sensor value from a second sensor, and a second sensor value from the first sensor is also different from a second sensor value from the second sensor), the present disclosure may calculate a Hall counter compensation value for decreasing the Hall counter value by 2 in the same direction as the spring tension direction of the sunroof.

In this case, the present disclosure may open or close the blind of the sunroof by applying a Hall counter compensation value for decreasing a Hall counter value by 2 to a second motor that moves the blind of the sunroof.

Next, the present disclosure may correct the position of the sunroof by controlling the rotation of a motor based on the calculated compensation value (S50).

Next, the present disclosure may determine whether there is a request for terminating a control operation of the sunroof (S60).

In addition, the present disclosure may terminate the sunroof control operation when the request for terminating the sunroof control operation is present.

As such, the present disclosure may prevent malfunction of a sunroof and may improve the safety and convenience of a user as a processor corrects a position change in a sunroof in a sleep mode based on a correction value calculated by comparing first sensor values received from a plurality of sensors in a wakeup mode before the sleep mode with second sensor values received from the plurality of sensors in the wakeup mode after the sleep mode.

Moreover, the present disclosure may prevent closing and opening failures caused by accumulated changes in a sunroof position.

Furthermore, the present disclosure may prevent a situation in which the sunroof is incorrectly closed due to incorrect learning load usage caused by incorrectly determining the sunroof position, and may prevent bodily injury caused by an increase in reverse power when a user's body is caught.

The present disclosure may prevent or alleviate sunroof cable wear and motor deterioration by preventing excessive initialization for sunroof position correction.

Also, the present disclosure may be applied to any system or component (e.g., a window, a tailgate, a seat, a charging door, a glass curtain, a sliding door) that estimates a position by using two Hall sensors, in addition to the sunroof position correction.

For example, when a vehicle is continuously turned on/off while the tailgate and the sliding door are open during car camping or camping, a position may not be aligned. Accordingly, the misalignment of a position may be prevented by applying the present disclosure.

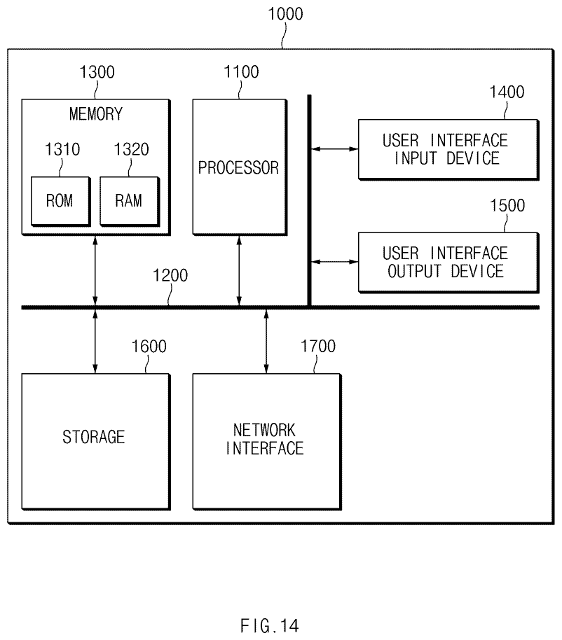

FIG. 14 shows an example computing system of a vehicle.

Referring to FIG. 14, a computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Accordingly, the operations of the method or algorithm described in connection with example embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and modifications may be made by one skilled in the art without departing from the essential characteristic of the present disclosure.

Accordingly, the example embodiments of the present disclosure are intended not to limit but to explain the technical idea of the present disclosure, and the scope and spirit of the present disclosure is not limited by the above example embodiments. The scope of protection of the present disclosure should be construed by the attached claims, and all equivalents thereof should be construed as being included within the scope of the present disclosure.

The present technology may prevent malfunction of a sunroof and may improve the safety and convenience of a user as a processor corrects a position change in a sunroof in a sleep mode based on a correction value calculated by comparing first sensor values received from a plurality of sensors in a wakeup mode before the sleep mode with second sensor values received from the plurality of sensors in the wakeup mode after the sleep mode.

Moreover, the present technology may prevent closing and opening failures caused by accumulated changes in a sunroof position.

Furthermore, the present technology may prevent a situation in which the sunroof is incorrectly closed due to incorrect learning load usage caused by incorrectly determining the sunroof position, and may prevent bodily injury caused by an increase in reverse power when a user's body is caught.

Besides, the present technology may prevent sunroof cable wear and motor deterioration by preventing excessive initialization for sunroof position correction.

Also, the present technology may be used by being applied to a system (a window, a tailgate, a seat, a charging door, a glass curtain, a sliding door, or the like) that estimates a position by using two Hall sensors in addition to the sunroof position correction.

According to an aspect of the present disclosure, a vehicle control apparatus may include a motor that moves a sunroof to open and close the sunroof, a plurality of sensors that detects rotation of the motor, a memory that stores sensor values received from the sensors, and a processor that controls the rotation of the motor based on the sensor values. The processor may compare first sensor values received from the plurality of sensors in the wakeup mode before the sleep mode with second sensor values received from the plurality of sensors in the wakeup mode after the sleep mode when a sleep mode is switched to a wakeup mode, may calculate a compensation value when the comparison result indicates that the first sensor values are different from the second sensor values, and may correct a location of the sunroof by controlling the rotation of the motor based on the calculated compensation value.

The processor may receive second sensor values from the plurality of sensors in the wakeup mode after the sleep mode when the sleep mode is switched to the wakeup mode when the first sensor values are compared with the second sensor values, and may extract first sensor values stored in the wakeup mode before the sleep mode from the memory, and may compare the first sensor values and the second sensor values, which correspond to a same time point.

The processor may calculate a Hall counter compensation value based on an edge for the different sensor values when the comparison result indicates that one of the first sensor values is different from one of the second sensor values when the compensation value is calculated.

The processor may calculate a Hall counter compensation value for increasing or decreasing a Hall counter value by 1 when the edge for the different sensor values is a falling edge, and may calculate the Hall counter compensation value for increasing or decreasing the Hall counter value by 1 when the edge for different sensor values is a rising edge.

The processor may calculate a Hall counter compensation value based on a previous movement direction of the sunroof when the comparison result indicates that the first sensor values are completely different from the second sensor values when the compensation value is calculated.

If the first sensor values and the second sensor values are completely different from each other, the processor may calculate a Hall counter compensation value for decreasing a Hall counter value by 2 when the previous movement direction of the sunroof is an opening direction and may calculate a Hall counter compensation value for increasing the Hall counter value by 2 when the previous movement direction of the sunroof is a closing direction.

The processor may calculate a Hall counter compensation value based on a spring tension direction of the sunroof when the comparison result indicates that the first sensor values are completely different from the second sensor values when the compensation value is calculated.

The processor may calculate a Hall counter compensation value for decreasing a Hall counter value by 2 in a direction the same as the spring tension direction of the sunroof when the first sensor values and the second sensor values are completely different from each other.

According to an aspect of the present disclosure, a vehicle system may include an interface device that receives a user command for operating a sunroof, and a vehicle control apparatus including a motor and a plurality of sensors to control movement of the sunroof depending on the user command. The vehicle control apparatus may compare first sensor values received from the plurality of sensors in the wakeup mode before the sleep mode with second sensor values received from the plurality of sensors in the wakeup mode after the sleep mode when a sleep mode is switched to a wakeup mode, may calculate a compensation value when the comparison result indicates that the first sensor values are different from the second sensor values, and may correct a location of the sunroof by controlling rotation of the motor based on the calculated compensation value.

According to an aspect of the present disclosure, a vehicle control method of a vehicle control apparatus including a motor and a plurality of sensors to control movement of a sunroof may include determining whether a sleep mode is switched to a wakeup mode, comparing first sensor values received from the plurality of sensors in the wakeup mode before the sleep mode with second sensor values received from the plurality of sensors in the wakeup mode after the sleep mode when the sleep mode is switched to the wakeup mode, calculating a compensation value when the comparison result indicates that the first sensor values and the second sensor values are different from each other, and correcting a location of the sunroof by controlling rotation of the motor based on the calculated compensation value.

Besides, a variety of effects directly or indirectly understood through the present disclosure may be provided.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle control apparatus of a vehicle, the vehicle control apparatus comprising:
a motor configured to move a sunroof of the vehicle to one of an open position and a closed position;
a plurality of sensors configured to detect rotation of the motor;
memory configured to store sensor values that are associated with rotation of the motor and are received from the plurality of sensors; and
a processor configured to:
store, in the memory, first sensor values, wherein the first sensor values are received from the plurality of sensors while the vehicle control apparatus is in a wakeup mode and before a first time at which the vehicle control apparatus switches from the wakeup mode to a sleep mode;
based on the vehicle control apparatus switching from the sleep mode to the wakeup mode at a second time after the first time, compare the first sensor values, stored in the memory, with second sensor values, wherein the second sensor values are received from the plurality of sensors after the second time and while the vehicle control apparatus is in the wakeup mode;
determine, based on the comparison indicating that the first sensor values are different from the second sensor values, an adjustment value; and
adjust a position of the sunroof by controlling, based on the adjustment value, rotation of the motor.

2. The vehicle control apparatus of claim 1, wherein the plurality of sensors comprise:
a first Hall sensor and a second Hall sensor, which are placed adjacent to each other on one side of the motor,
wherein the first Hall sensor is configured to detect the rotation of the motor and output a first square wave signal, and
wherein the second Hall sensor is configured to detect the rotation of the motor and output a second square wave signal with a phase difference of 90 degrees with respect to the first square wave signal.

3. The vehicle control apparatus of claim 1, wherein the processor is configured to adjust the position of the sunroof by reverting a positional change of the sunroof that was not detected while the vehicle control apparatus was in the sleep mode, and
wherein the processor is further configured to:
write, in the memory, the one or more sensor values received from the plurality of sensors while the vehicle control apparatus is in the wakeup mode; and
stop writing, in the memory, any additional sensor values while the vehicle control apparatus is in the sleep mode.

4. The vehicle control apparatus of claim 1, wherein the processor is configured to compare the first sensor values with the second sensor values by:
receiving, from the plurality of sensors, the second sensor values while the vehicle control apparatus is in the wakeup mode after switching from the sleep mode;
retrieving, from the memory, the first sensor values that were stored while the vehicle control apparatus was in the wakeup mode before switching to the sleep mode; and
comparing the first sensor values and the second sensor values.

5. The vehicle control apparatus of claim 4, wherein the processor is further configured to:
identify a current rotational direction of the motor at a third time when the first sensor values are retrieved from the memory, wherein the third time is after the second time at which the vehicle control apparatus switches from the sleep mode to the wakeup mode; and
identify, based on the current rotational direction of the motor at the third time being a forward rotational direction, a sensor value, of the first sensor values, that was received when the motor was rotating in the forward rotational direction.

6. The vehicle control apparatus of claim 4, wherein the processor is further configured to:
identify a current rotational direction of the motor at a third time when the first sensor values are retrieved from the memory, wherein the third time is after the second time at which the vehicle control apparatus switches from the sleep mode to the wakeup mode; and
identify, based on the current rotational direction of the motor at the third time being a reverse rotational direction, a sensor value, of the first sensor values, that was received when the motor was rotating in the reverse rotational direction.

7. The vehicle control apparatus of claim 1, wherein the processor is configured to determine the adjustment value by:
based on the comparison indicating that one of the first sensor values is different from a corresponding value of the second sensor values, determining a Hall counter adjustment value further based on an edge associated with the different sensor values of the first sensor values and the second sensor values.

8. The vehicle control apparatus of claim 7, wherein the processor is configured to determine the Hall counter adjustment value by performing one of:
based on the edge associated with the different sensor values being a falling edge, determining a first adjustment value as the Hall counter adjustment value for adjusting a Hall counter value by 1; or
based on the edge associated with the different sensor values being a rising edge, determining a second adjustment value as the Hall counter adjustment value for adjusting the Hall counter value by 1.

9. The vehicle control apparatus of claim 8, wherein the processor is configured to determine the Hall counter adjustment value by:
determining an absolute value of the Hall counter adjustment value to be same regardless of whether a rotational direction of the motor is a forward direction or a reverse direction.

10. The vehicle control apparatus of claim 1, wherein the processor is configured to determine the adjustment value by:
based on the comparison indicating that the first sensor values are different from the second sensor values for each of the plurality of sensors, determining a Hall counter adjustment value further based on a previous movement direction of the sunroof.

11. The vehicle control apparatus of claim 10, wherein the processor is configured to determine the adjustment value by, based on the comparison indicating that the first sensor values are different from the second sensor values for each of the plurality of sensors, performing one of:
determining the Hall counter adjustment value for decreasing a Hall counter value by 2 based on the previous movement direction of the sunroof being an opening direction; or
determining the Hall counter adjustment value for increasing the Hall counter value by 2 based on the previous movement direction of the sunroof being a closing direction.

12. The vehicle control apparatus of claim 1, wherein the processor is configured to determine the adjustment value by:
based on the comparison indicating that the first sensor values are different from the second sensor values for each of the plurality of sensors, determining a Hall counter adjustment value further based on a spring tension direction of the sunroof.

13. The vehicle control apparatus of claim 12, wherein the processor is configured to determine the adjustment value by:
based on the comparison indicating that the first sensor values are different from the second sensor values for each of the plurality of sensors, determining the Hall counter adjustment value for decreasing a Hall counter value by 2 in the spring tension direction of the sunroof.

14. A vehicle system of a vehicle, the vehicle system comprising:
a user interface configured to receive a user command for operating a sunroof of the vehicle; and
a vehicle control apparatus comprising:
a motor; and
a plurality of sensors configured to control movement of the sunroof according to the user command,
wherein the vehicle control apparatus is configured to:
receive, from the plurality of sensors while the vehicle control apparatus is in a wakeup mode and before a first time at which the vehicle control apparatus switches from the wakeup mode to a sleep mode, first sensor values;
based on the vehicle control apparatus switching from the sleep mode to the wakeup mode at a second time after the first time, compare the first sensor values with second sensor values, wherein the second sensor values are received from the plurality of sensors after the second time and while the vehicle control apparatus is in the wakeup mode;
determine, based on the comparison indicating that the first sensor values are different from the second sensor values, an adjustment value; and
adjust a position of the sunroof by controlling, based on the adjustment value, rotation of the motor.

15. A method performed by an apparatus of a vehicle, the method comprising:
receiving, from a plurality of sensors while the apparatus is in a wakeup mode and before a first time at which the apparatus switches from the wakeup mode to a sleep mode, first sensor values;
based on determining that the apparatus has switched from the sleep mode to the wakeup mode at a second time after the first time, comparing the first sensor values with second sensor values, wherein the second sensor values are received from the plurality of sensors after the second time and while the apparatus is in the wakeup mode;
determining, based on the comparison indicating that the first sensor values are different from the second sensor values, an adjustment value; and
adjusting a position of a sunroof of the vehicle by controlling, based on the adjustment value, rotation of a motor associated with the sunroof.

16. The method of claim 15, wherein the determining of the adjustment value comprises:
based on the comparison indicating that one of the first sensor values is different from a corresponding value of the second sensor values, determining a Hall counter adjustment value for increasing or decreasing a Hall counter value by 1 further based on an edge associated with the different sensor values of the first sensor values and the second sensor values.

17. The method of claim 15, wherein the determining of the adjustment value comprises:
based on the comparison indicating that the first sensor values are different from the second sensor values for each of the plurality of sensors, determining a Hall counter adjustment value further based on a previous movement direction of the sunroof.

18. The method of claim 17, wherein the determining of the adjustment value further comprises, based on the comparison indicating that the first sensor values are different from the second sensor values for each of the plurality of sensors, performing one of:
determining the Hall counter adjustment value for decreasing a Hall counter value by 2 based on the previous movement direction of the sunroof being an opening direction; or
determining the Hall counter adjustment value for increasing the Hall counter value by 2 based on the previous movement direction of the sunroof being a closing direction.

19. The method of claim 15, wherein the determining of the adjustment value comprises:
based on the comparison indicating that the first sensor values are different from the second sensor values for each of the plurality of sensors, determining a Hall counter adjustment value further based on a spring tension direction of the sunroof.

20. The method of claim 19, wherein the determining of the adjustment value further comprises:
based on the comparison indicating that the first sensor values are different from the second sensor values for each of the plurality of sensors, determining the Hall counter adjustment value for decreasing a Hall counter value by 2 in the spring tension direction of the sunroof.
